(19) United States
(12) Patent Application Publication
(10) Pub. No.: US 2017/0177632 A1
(43) Pub. Date: Jun. 22, 2017

(54) METHOD AND APPARATUS FOR SAVING WEB CONTENT

(71) Applicant: Samsung Electronics Co., Ltd., Gyeonggi-do (KR)

(72) Inventors: Sumit KUMAR, Noida (IN); Bharat BHUSHAN, Noida (IN); Nikhil CHAUHAN, Noida (IN)

(73) Assignee: Samsung Electronics Co., Ltd.

(21) Appl. No.: 15/383,505

(22) Filed: Dec. 19, 2016

(30) Foreign Application Priority Data
Dec. 18, 2015 (IN) 4167/DEL/2015

(51) Int. Cl. G06F 17/30; G06F 3/0482

(52) U.S. Cl. CPC G06F 17/30312; G06F 17/30867; G06F 17/30554; G06F 3/0482

(57) ABSTRACT

The present invention relates to a method for storing of network host provided content at a non-host location. In accordance with an embodiment, an event corresponding to storing of at least one network host provided content or web page is detected on a device where a user accessing a browsing application to view the web page. Upon detecting the network host provided content or web page and retrieval information corresponding to the web page is stored at a non-host location in a mapped relationship with each other. The retrieval information is a information of the searchable type based on the information present in the network host provided content.

### CROSS-REFERENCE TO RELATED APPLICATION(S)

This application claims priority from Indian Patent Application No. 4167/DEL/2015, filed on Dec. 18, 2015, in the India Patent Office, the disclosure of which is incorporated herein by reference in its entirety.

### TECHNICAL FIELD

The present invention relates web browsing, and, more specifically, to saving web content.

### BACKGROUND

Browser application has become an important technology aspect with Internet being the ocean of information and with increasing number of Internet users. The current era is dedicated to technologies of information sharing that enhances the decision making power of individual users. Consequently, the browser application has become an important and must-have application in devices such as desktop, tablet, notebook, and smart phones etc. Further development added offline features to the browser application such as formatting and editing documents, like text documents and presentations, in the absence of a connection to application servers in the cloud. Some other browser applications handle loss of internet connectivity as well. Accordingly, these browser applications save certain information locally on the device. The browser application is further capable of saving web pages and later reloading the saved web pages. Presently, when the user saves a web page from the browser application, the user is required to provide or select a name and location for storing the web page. The browser application will usually save web pages as plain text only, basic HTML page, complete Webpage, and Web Archive, as selected by the user. When the user tries to retrieve the saved web page, the user has to traverse to the location and fetch the web page from the location manually. The browser application then loads the fetched web page. However, the user cannot access the saved web pages using the browser application without having location information of that webpage as the browser application does not have the information about saved contents. This leads to a frustrated user-experience as the user may not remember the name of the web page or location of the saved web page. Further, the user has to repeat the same process for retrieving and accessing multiple saved web pages.

### SUMMARY

This summary is provided to introduce a selection of concepts in a simplified format that are further described in the detailed description of the invention. This summary is not intended to identify key or essential inventive concepts of the claimed subject matter, nor is it intended for determining the scope of the claimed subject matter.

In accordance with the purposes of the invention, the present invention as embodied and broadly described herein, provides a methods and apparatus for storing of network host provided content at a non-host location. Accordingly, an event corresponding to storing of at least one network host provided content or web content is detected on a device where a user is accessing a browsing application to view a web page. Examples of the web content include, but not limited to, the web page itself and document obtained from the web page such as PDF document, text document, presentation document, audio file, image file, video file, and animation file. Upon detecting, the network host provided content or web content and retrieval information corresponding to the web content is stored at a non-host location in a mapped relationship with each other. The retrieval information is information of searchable type based on the information present in the network host provided content. Examples of such retrieval information include, but not limited, context of the web content, high frequency words in the web content, keywords in the web content, read words in the web content. The non-host location can be any device different from the network host providing the web content. In an example, the network host is a server providing the web page. Thus, the non-host location can be a web browser application, a local memory, a local network, a local device, a local database, and a location other than the network host. In addition, the web content is automatically stored in the non-host location is based on the retrieval information.

Further, the saved web content is automatically categorized based on the retrieval information and displayed to the user. Accordingly, availability of at least one offline stored content on the non-host location is detected. Upon detecting, the retrieval information mapped to the at least one detected offline stored content is fetched from the non-host location. The at least one detected offline stored content is then categorized based on at least one attribute of the retrieval information and one or more predefined categorization rules. The categorization rules identify the at least one attribute of the retrieval information. Upon categorizing, information of the at least one offline stored content is displayed in a first graphical user interface within a browser in accordance with the categorization.

Furthermore, the saved web content can be searched based on the retrieval information. Accordingly, a graphical user interface within a browser is provided to the user. The graphical user interface is configured to receive at least one search criterion for searching of the offline stored content. Thereafter, the retrieval information is fetched from the non-host location. Upon fetching, the at least one search criterion is compared with the retrieval information. Based on the comparison, at least one offline stored content mapped with the retrieval information from the non-host location is fetched. Upon fetching, information at least one offline stored content in displayed in a graphical user interface within the browser.

Thus, the present invention provides a mechanism to automatically store web content along with mapped retrieval information in a non-host location upon detecting an event corresponding to saving the web content from a browser application. Further, a mechanism is provided in the browser application to enable the user to search the saved web content based on retrieval information. In addition, the saved web content are automatically categorized based on the retrieval information and displayed to the user.

The advantages of the invention include, but are not limited to, providing a facility for auto/intelligent saving of web content to any non-host location based on metadata or retrieval information without giving a specific storage location. The retrieval information is information of searchable type based on information present in the web content. The retrieval information is saved in the non-host location in a mapped relationship with the web content. The retrieval information enables efficient classification and searching of the stored web content. This auto/intelligent saving provides a better user-experience is manual steps for saving web content are reduced to one step, i.e., providing a request of saving the web content. In addition, the location of saved web content is automatically updated without any manual intervention. Further, the

Further, a flexibility is provided to the user to search the saved web content from the browsing application itself based on the retrieval information without having to remember the location of the saved web content. This eliminates the need for remembering the file name, storage location, and link of the web content. Further, the search is based on the retrieval information, which itself is information of searchable type based on the information contained within the web content. This provides an efficient searching as the text based searching is performed on the retrival information and not entire memory of the non-host location.

Further, the saved web pages are automatically categorized or classified based on the retrieval information. This eliminates manual steps of classifying, and therefore a better user-experience is provided. These aspects and advantages will be more clearly understood from the following detailed description taken in conjunction with the accompanying drawings and claims.

### BRIEF DESCRIPTION OF THE DRAWINGS

To further clarify advantages and aspects of the invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings, which are listed below for quick reference.

FIG. 1 illustrates an exemplary method for storing of network host provided content at a non-host location, in accordance with an embodiment of present invention;

FIGS. 2A and 2B illustrate an exemplary method for displaying offline stored content, in accordance with an embodiment of present invention;

FIG. 3 illustrates an exemplary method for enabling searching of offline stored content, in accordance with an embodiment of present invention;

FIG. 4 illustrates an exemplary apparatus for storing, displaying, and searching of offline stored content, in accordance with an embodiment of present invention;

FIG. 5 schematically illustrates an exemplary networked environment that implements the apparatus for storing, displaying, and searching of offline stored content, in accordance with an embodiment of the present invention;

FIGS. 6A and 6B illustrates an example manifestation of storing of network host provided content at a non-host location in the networked environment, in accordance with an embodiment of present invention;

FIG. 7 illustrates a first example manifestation of displaying offline stored content, in accordance with an embodiment of present invention;

FIG. 8 illustrates a second example manifestation of displaying offline stored content, in accordance with an embodiment of present invention;

FIGS. 9A and 9B illustrate third example manifestation of displaying offline stored content, in accordance with an embodiment of present invention;

FIGS. 10A and 10B illustrate a first example manifestation of searching of offline stored content, in accordance with an embodiment of present invention;

FIG. 11 illustrates a second example manifestation of searching of offline stored content, in accordance with an embodiment of present invention;

FIG. 12 illustrates a third example manifestation of searching of offline stored content, in accordance with an embodiment of present invention; and

FIG. 13 illustrates a typical hardware configuration of an apparatus, which is representative of a hardware environment for practicing the present invention.

It may be noted that to the extent possible, like reference numerals have been used to represent like elements in the drawings. Further, those of ordinary skill in the art will appreciate that elements in the drawings are illustrated for simplicity and may not have been necessarily drawn to scale. For example, the dimensions of some of the elements in the drawings may be exaggerated relative to other elements to help to improve understanding of aspects of the invention. Furthermore, the one or more elements may have been represented in the drawings by conventional symbols, and the drawings may show only those specific details that are pertinent to understanding the embodiments of the invention so as not to obscure the drawings with details that will be readily apparent to those of ordinary skill in the art having benefit of the description herein.

### DETAILED DESCRIPTION

It should be understood at the outset that although illustrative implementations of the embodiments of the present disclosure are illustrated below, the present invention may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching and illuminating some embodiments and their specific features and elements and does not limit, restrict or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having an ordinary skill in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfil the requirements of uniqueness, utility and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should NOT be necessarily taken as limiting factors to the attached claims. Further, the terms ‘offline stored content’ and ‘offline web content’, ‘stored web content’ can be interchangeably throughout the specification. The attached claims and their legal equivalents can be realized in the context of embodiments other than the ones used as illustrative examples in the description below.

Further, the browser applications enable saving or downloading web content, such as document, images, audio, and video from the web pages. Upon saving, the browser applications save information corresponding saved or downloaded content such as list all downloaded content & metadata corresponding to the saved or downloaded content. The metadata includes name of the downloaded content, type of the downloaded content (for example, text document, image, audio), size of the downloaded content, link to corresponding web page, date of downloading, and location of downloaded content in the device. Further, the browser applications enables searching of the downloaded content based on the metadata. However, the browser applications do not provide any feature to classify the downloaded content in accordance with user requirements or downloaded content itself. As such, manual intervention is necessitated for classifying the downloaded content such as changing location of the downloaded content in accordance with context of the content. Additionally, the metadata is not updated to indicate any change in location of the downloaded content. In addition, the browser applications are unable to save information provided by user such as ratings and number of visits, and information from inside the content such as keywords. This again necessitates the user either to remember the metadata and other information or to traverse and open each of the downloaded web content.

Various solutions are available which provide an enhanced browsing experience by overcoming above deficiencies. In one solution, a web-server provides web services to a client computer via a computer network such as Internet. Web-functionality is statically partitioned between the client computer and the web-server. For example, those web-browser tasks that require intensive computation and complex resource scheduling are partitioned or allocated to the web-server. While those web-browser tasks that are bandwidth intensive but easy to implement in hardware, such as user-input capturing and rendering texts, images, audio, and video, etc., are allocated to client computer. The web-server performs predetermined computational tasks for the client computer to process user inputs from the client computer and web page contents requested by the client computer. The inputs from the client computer can be either an initialization request or request for an existing browsing session.

If the input is an initialization request, the web server creates a new web session and allocates a storage space for the client computer for the web-browsing processing on the web server. Upon receiving response for the initialization request, the client computer establishes the web session identified with a session ID. The session ID and other session information may be stored on client computer or on the storage space. If the input is request for an existing browsing session, the web server checks whether there is any stored session associated with the client computer based on the session ID. Upon determining, the web server recovers a stored browser session, session states, session data, and stored web pages, such that the client computer continues from the recovered stored browser session. Thereafter, the client computer receives web resources such as texts, images, and URLS from the server. The client computer loads web resources using local libraries and displays the web page to the user

Thus, the solution describes a method of enhancing the experience of web surfing by dynamically performing the operation of rendering on the client side by loading the resources using a local library at the client side. Additionally, the solution enables saving of details corresponding to the browser session. However, the solution does not save the metadata or user input corresponding to web pages locally on the client computer. Further, the solution does not enable searching of the saved web pages by the user on the client side using the metadata or the user input. Further, the solution does not provide any feature to classify the received web resources upon downloading or saving in accordance with user requirements or downloaded content itself. As such, manual intervention is necessitated for classifying the downloaded content such as changing location of the saved web resources in accordance with context or content of the web resources.

In another solution, a current-visitor context of a current visitor to a web page in a current web-browsing session is accessed. The current-visitor context identifies how the visitor has accessed or been directed to the web page. The current-visitor context includes data associated with the current visitor such as demographic data, background data, network-access data, network-traffic data, actions taken by the current visitor, and traffic source. Based on analysis of the current-visitor context, a particular web page from multiple possible instances of the web page is selected for presentation to the current visitor. The multiple possible instances of the web pages include specific features or combination of features from the original web page based on the visitor context. The particular web page is substantially most likely to generate a highest expected outcome from interaction with the web page by the current visitor as indicated by the current-visitor context. Thus, the solution enables processing the results from a web server by understanding the context of a user and based on that context determining the web page where probability of generating outcome by the user is maximized. However, the solution does not provide any methodology for the saving web content including web pages, and document and images from the web pages on a client computer. Further, the solution is silent about saving metadata and other information in relation to the saved web content and searching of any such saved web content using the saved metadata and other information. In addition, the solution is directed towards creating modified web pages from original web page based on user activity while accessing the original web page. Thus, each time a modified web page is presented to user. However, the solution does not classify new web pages once the new web pages are saved on the device of the user. In one another solution, a system records browsing activity of a user using a browser. The browsing activity includes how frequently the user has browsed documents, which documents have been browsed recently by the user, and how frequently the user has browsed documents that correspond to the user's bookmarks or favourites. The document can be an e-mail, a website, a business listing, a file, a combination of files, files with embedded links to other files, a news group posting, a blog, a web advertisement, and a digital map. The system then determines browsing statistics from the recorded browsing activity and graphically displays the browsing statistics to the user via the browser. The browsing statistics may be used in adjusting the ranking of search results provided to the user associated with the browsing statistics. Thus, the solution describes criteria for the collection of the browsing history based on the documents accessed at different times and represents them in the form of a web browser. The browsing history is also used to boost selected results among the search results or to adjust the ranking of the search results. For example, documents whose URLs are visited most frequently by a user may be boosted among a set of search results returned to that user as a result of an executed search. However, the solution does not focus on management of the saved web content. Specifically, the solution is silent about saving metadata and other information in relation to the saved web content and subsequent searching of any such saved web content using the saved metadata and other information. In addition, the solution requires manual classification of web content from the web pages once the web pages are saved on the device of the user.

In yet another solution, an automatically upgradeable software application pushes targeted advertising based upon demographics and user interaction with the computer. The software application is downloaded from a server via the Internet and demographic information on the user is acquired by the server and used for determining what banner advertising will be sent to the user. The software application further targets the advertisements in response to normal user interaction, or use, of the computer. Associated with each banner advertisement is a set of data that is used by the software application in determining when a particular banner is to be displayed. This includes the specification of certain programs that the user may have so that, when the user runs the program (such as a spreadsheet program), an advertisement will be displayed that is relevant to that program (such as an advertisement for a stock brokerage). This provides two-tiered, real-time targeting of advertising—both demographically and reactively. The software application includes programming that accesses the server on occasion to determine if one or more components of the application need upgrading to a newer version. If so, the components are downloaded and installed without requiring any input or action by the user. Thus, the solution provides real time targeted advertisement based on user actions to a particular category of information. However, the solution does not focus on management of the saved web content. Specifically, the solution is silent about saving metadata and other information in relation to the saved web content and subsequent searching of any such saved web content using the saved metadata and other information. In addition, the solution requires manual classification of web content from the web pages once the web pages are saved on the device of the user.

As can be gathered from above, the above-mentioned solutions do not provide intelligent storing of web content as per user's interest and/or requirement. Rather, the above-mentioned solutions store the web content at a predefined static location, which necessitate the user to manually move the stored web content to location as per user's interest. Likewise, the above-mentioned solutions store the web content at a location manually specified by the user. Further, the above-mentioned solutions do not provide much flexibility in terms of enabling the user to search the saved web content from the browsing application without necessitating remembering details of the saved web content. In addition, the above-mentioned solutions necessitate manual intervention for classifying stored web contents in accordance with user requirements.

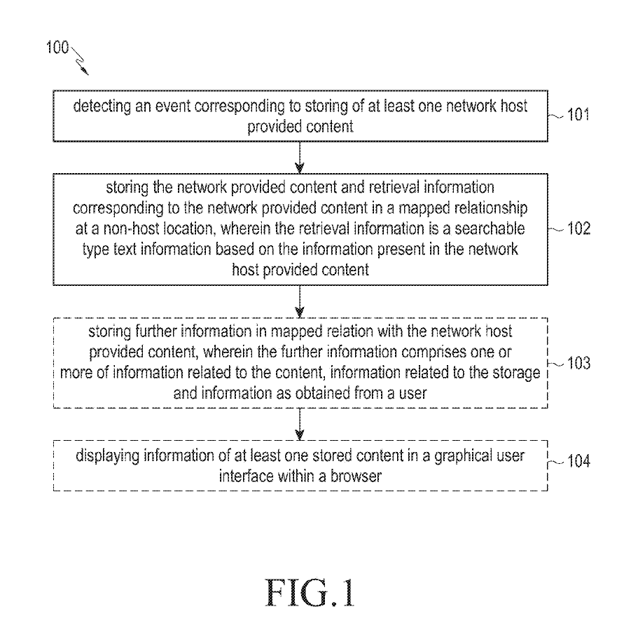

FIG. 1 illustrates an exemplary method (100) for storing of network host provided content at a non-host location, in accordance with an embodiment of present invention.

The network host provided content is for example, content provided by the network host providing the web content. In such embodiment, the method (100) comprises: detecting (101) an event corresponding to storing of at least one network host provided content; and storing (102) the network provided content and retrieval information corresponding to the network provided content in a mapped relationship at a non-host location, wherein the retrieval information is information of searchable type based on the information present in the network host provided content. The information of the searchable type comprise at least one of text information, image information, audio information, and video information. The retrieval information is obtained prior to storing network provided content. Upon analysing the retrieval information, the retrieval information is mapped with the network provided content and saved at the non-host location.

Further, the non-host location comprises one or more of a web browser application, a local memory, a local network, a local database, a local device, and a location other than the network host.

Further, the network host provided content is automatically stored in the non-host location based on the retrieval information. As such, the retrieval information is analysed and a folder is created at the non-host location based on the retrieval information. Upon creating the folder, web content is automatically stored under the corresponding folders.

Further, the method (100) comprises: storing (103) further information in mapped relation with the network host provided content, wherein the further information comprises one or more of information related to the content, storage dependent information, and information as obtained from a user.

Further, the information related to the storage comprises one or more of time of storing and location of storing.

Further, the information related to the content comprises one or more of name of the content, type of the content, size of the content, source of the content, address of the source of the content, and metadata related to the content.

Further, the information as obtained from the user comprises one or more of user details, rating as provided by the user to the content, number of times the content has been viewed, and remarks as provided by the user to the content.

Further, the information related to the content is retrieved prior to storing of the network host provided content at the non-host location.

Further, the information related to the content is retrieved post storing of the network host provided content at the non-host location.

Further, the information related to the storage is retrieved post storing of the network host provided content at the non-host location.

Further, the information as obtained from the user is retrieved prior to storing of the network host provided content at the non-host location.

Further, the information as obtained from the user is retrieved post storing of the network host provided content at the non-host location.

Further, the information as obtained from the user is retrieved post a user action on the content at the non-host location.

Further, the method (100) comprises: detecting an event corresponding to storing of a plurality of network host provided contents; and storing each of the plurality of network host provided contents and retrieval information corresponding to each of the plurality of network host provided contents in a mapped relationship at a non-host location.

Further, the method (100) comprises: displaying (104) information of at least one stored content in a graphical user interface within a browser.

Further, the step of displaying (104) information of the stored content comprises displaying a menu in a graphical user interface within the browser.

Further, the step of displaying (104) comprises creating a menu corresponding to said at least one stored content.

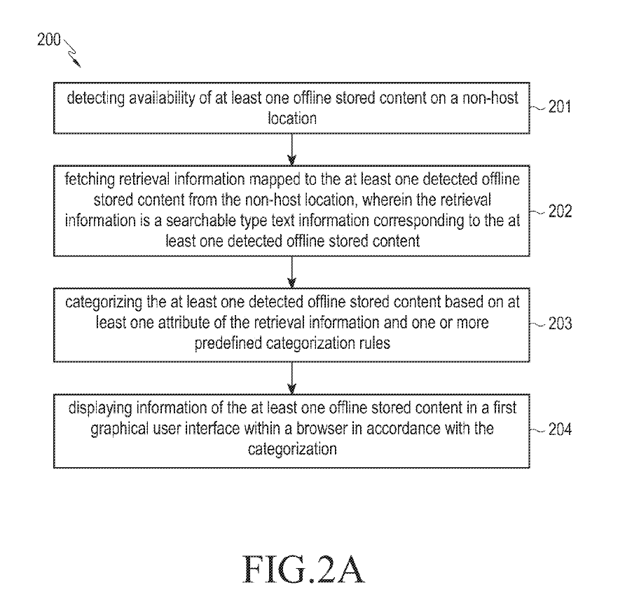

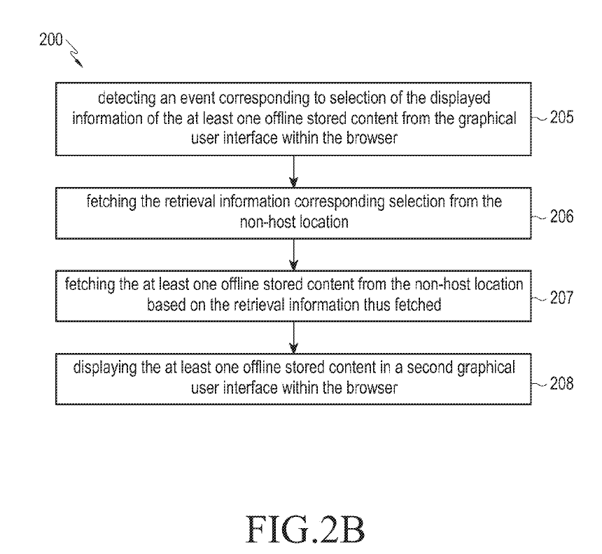

FIGS. 2A & 2B illustrate an exemplary method (200) for displaying offline stored content, in accordance with an embodiment of present invention.

In such embodiment, as illustrated in FIG. 2A, the method (200) comprises: detecting (201) availability of at least one offline stored content on a non-host location; fetching (202) retrieval information mapped to the at least one detected offline stored content from the non-host location, wherein the retrieval information is information of searchable type corresponding to the at least one detected offline stored content; categorizing (203) the at least one detected offline stored content based on at least one attribute of the retrieval information and one or more predefined categorization rules; and displaying (204) information of the at least one offline stored content in a first graphical user interface within a browser in accordance with the categorization. The information of the searchable type comprise at least one of text information, image information, audio information, and video information.

The method (200) further comprises fetching further information mapped to the at least one detected offline stored content from the non-host location, wherein the further information comprises one or more of information related to the content, information related to the storage and information as obtained from a user.

Thus, the step of categorization (203) is further based on the fetched further information.

Further, the step of fetching (202) the retrieval information and the step of fetching the further information is based on a pre-stored content.

Further, the one or more categorization rules identify the at least one attribute of the retrieval information and the further information for categorization.

Further, the step of displaying (204) information of the at least one offline stored content comprises displaying a menu in the first graphical user interface within the browser.

Further, as illustrated in FIG. 2B the method (200) further comprises: detecting (205) an event corresponding to selection of the displayed information of the at least one offline stored content from the graphical user interface within the browser; fetching (206) the retrieval information corresponding to the selection from the non-host location; fetching (207) the at least one offline stored content from the non-host location based on the retrieval information thus fetched; and displaying (208) the at least one offline stored content in a second graphical user interface within the browser.

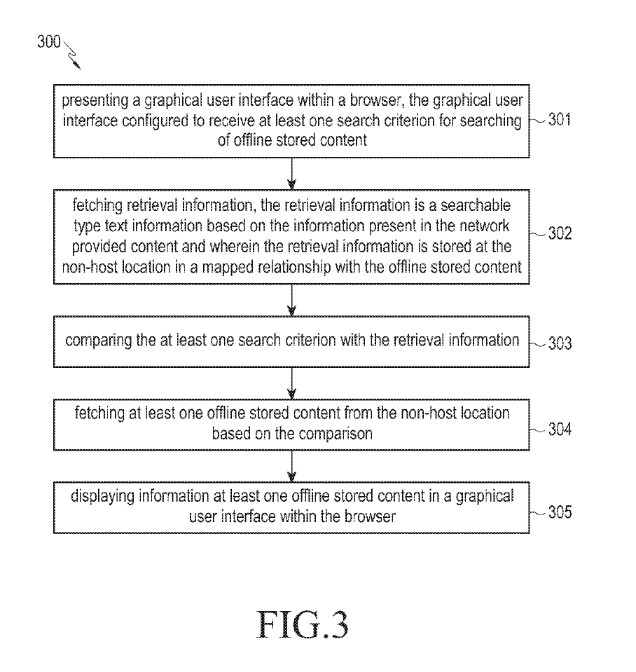

FIG. 3 illustrates an exemplary method (300) for enabling searching of offline stored content, in accordance with an embodiment of present invention.

In such embodiment, the method (300) comprises: presenting (301) a graphical user interface within a browser, the graphical user interface configured to receive at least one search criterion for searching of offline stored content; fetching (302) retrieval information, the retrieval information is information of searchable type based on the information present in the network provided content and wherein the retrieval information is stored at the non-host location in a mapped relationship with the offline stored content; comparing (303) the at least one search criterion with the retrieval information; fetching (304) at least one offline stored content from the non-host location based on the comparison; and displaying (305) information at least one offline stored content in a graphical user interface within the browser. The information of the searchable type comprise at least one of text information, image information, audio information, and video information.

The method (300) further comprises fetching further information mapped to the at least one detected offline stored content from the non-host location, wherein the further information comprises one or more of information related to the content, information related to the storage and information as obtained from a user.

Thus, the step of comparing (303) is further based on the fetched further information.

Further, the method (300) comprises: detecting an event corresponding to selection of an offline stored content; and displaying the offline stored content in a graphical user interface within the browser on the basis of the retrieval information.

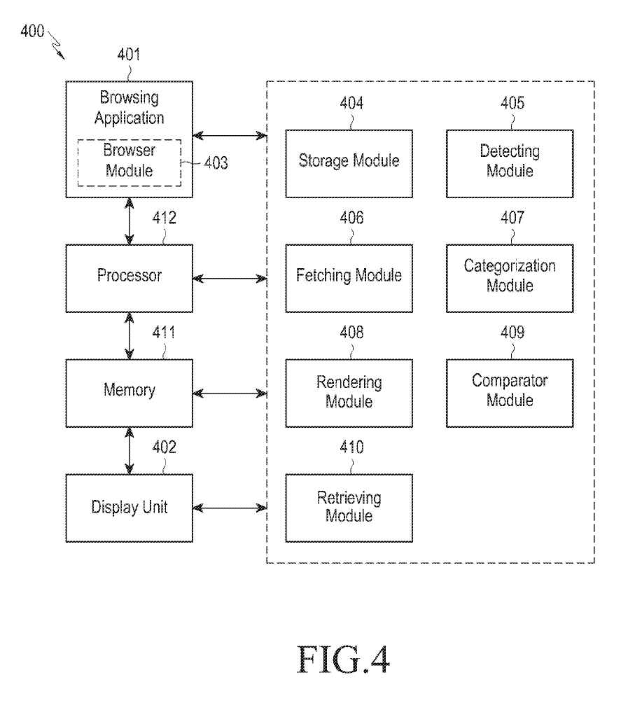

FIG. 4 illustrates an exemplary apparatus for storing, displaying, and searching of offline stored content, in accordance with an embodiment of present invention.

As illustrated in FIG. 4, the present invention further provides an apparatus (400) implementing the aforesaid methods as illustrated in FIGS. 1, 2, & 3 in accordance with an embodiment. The apparatus (400) can be any electronic device having a web browsing application (401) (hereinafter referred to as browsing application) as an integral part. For the sake of brevity, only one browsing application is illustrated. It would be understood that the apparatus (400) can include a plurality of browsing applications. Examples of such apparatus (400) include, but not limited to, smart television (TV), smart phone, laptop, tablet, notebook, personal digital assistance (PDA), and desktop personal computer (PC).

Further, the apparatus (400) includes display unit (402) adapted to display various elements such as images, texts, and videos. Examples include, but not limited to, depicting user-interface corresponding to the browsing application (401), depicting a list of applications, including the browsing application (401), available on the apparatus (400), depicting user-interface corresponding to each of the applications, and depicting various features of the apparatus (400).

According to the present invention, the apparatus (400) implements method for storing of network host provided content or web content, as described in FIG. 1 above, in accordance with an embodiment of present invention. As such, a network host provided content or web content is displayed on the display unit (402) via the browsing application (401), when a user is accessing the browsing application (401) to view one or more web pages. Examples of the web content include, but not limited to, the web pages itself and documents obtained from the web pages such as PDF document, text document, presentation document, audio file, image file, video file, and animation file. The browsing application (401) includes a browser module (403) for detecting an event corresponding to storing of at least one network host provided content. As would be understood, the browser module (403) includes various components of the browsing application (401) such as user interface, layout engine, rendering engine, JavaScript interpreter, UI backend, networking component, and data persistence component that performs various necessary functions of the browsing application (401).

The apparatus (400) further includes a storing module (404) for storing the network host provided content and retrieval information corresponding to the network provided content in a mapped relationship at a non-host location, wherein the retrieval information is information of searchable type based on the information present in the network provided content. The information of the searchable type comprise at least one of text information, image information, audio information, and video information.

Further, the apparatus (400) implements method for displaying of offline stored content, as described in FIG. 2 above, in accordance with an embodiment of present invention. As such, the apparatus (400) further includes a detecting module (405) for detecting availability of at least one offline stored content on the non-host location. The apparatus (400) further includes a fetching module (406) for fetching retrieval information mapped to the at least one detected offline stored content from the non-host location, wherein the retrieval information is information of searchable type corresponding to the at least one detected offline stored content. The information of the searchable type comprise at least one of text information, image information, audio information, and video information. In addition, the fetching module (406) is configured to fetch further information mapped to the at least one detected offline stored content from the non-host location, wherein the further information comprises at least one of information related to the content, information related to the storage and user-provided information corresponding to the at least one detected offline stored content.

The apparatus (400) further includes a categorization module (407) for categorizing the at least one detected offline stored content based on at least one attribute of the retrieval information and one or more predefined categorization rules. Additionally, the categorization module (407) can categorize the at least one detected offline stored content based on at least one attribute of the further information along with the retrieval information. The apparatus (400) further includes a rendering module (408) for displaying information of the at least one offline stored content in a first graphical user interface within a browser in accordance with the categorization. The browser can be the browsing application (401). As would be understood, the display unit (402) displays the first graphical user interface through the browsing application (401) for displaying the information of the at least one offline stored content.

Further, the apparatus (400) implements method for enabling searching of an offline webpage, as described in FIG. 3 above, in accordance with an embodiment of present invention. As such, the browser module (403) includes a graphical user interface module (not shown in the figure) for presenting a graphical user interface configured to receive at least one search criterion for searching of offline stored content.

Further, the fetching module (406) is configured for fetching retrieval information, the retrieval information is information of searchable type based on the information present in the network provided content and wherein the retrieval information is stored at the non-host location in a mapped relationship with the offline stored content. The information of the searchable type comprise at least one of text information, image information, audio information, and video information. In addition, the fetching module (406) is configured to fetch further information mapped to the at least one detected offline stored content from the non-host location, wherein the further information comprises at least one of information related to the content, information related to the storage and user-provided information corresponding to the at least one detected offline stored content.

Further, the apparatus (400) includes a comparator module (409) for comparing the at least one search criterion with the retrieval information. Additionally, the comparator module (409) can compare the at least one search criterion with the further information along with the retrieval information.

Further, the apparatus (400) includes a retrieving module (410) for retrieving at least one offline stored content from the non-host location based on the comparison.

Further, the rendering module (408) is configured for displaying information at least one offline stored content in a graphical user interface within the browser. The browser can be the browsing application (401). As would be understood, the display unit (402) displays the graphical user interface through the browsing application (401) for displaying the information of the at least one offline stored content.

Further, the browser module (403) is adapted to detect an event corresponding to selection of an offline stored content and the rendering module (410) is further adapted to displaying the offline stored content in a graphical user interface within the browser on the basis of the retrieval information.

Further, the apparatus (400) includes a memory (411) coupled to the above-mentioned modules. In one aspect of the invention, the storing module (404) stores the network host provided content, the retrieval information, the further information, and corresponding mapped relationships in the memory (411). The memory (411) may further include other data as necessary.

Further, the apparatus (400) includes a processor (412) adapted to perform necessary functions of the apparatus (400) and to control the functions of the above-mentioned units of the apparatus (400).

It would be understood that the apparatus (400) and the processing unit (412) may include various hardware modules/units/components or software modules or a combination of hardware and software modules as necessary for implementing the invention.

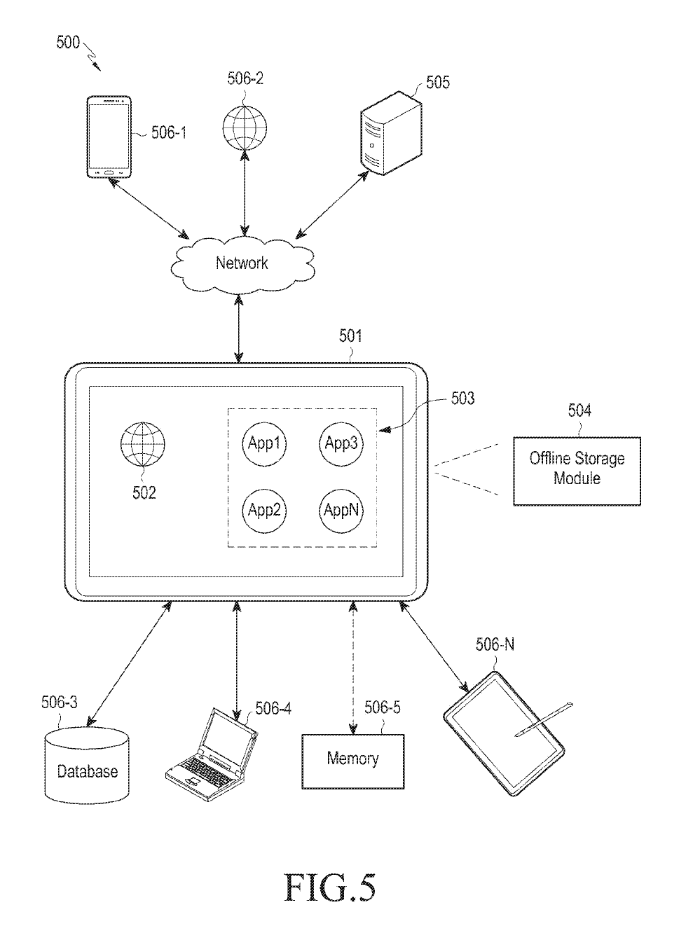

For the ease of understanding, the forthcoming descriptions of FIGS. 5-13 illustrate implementation of various aspects of the invention.

FIG. 5 schematically illustrates an exemplary networked environment (500) that implements an apparatus (501) for storing, displaying, and searching of offline stored content, in accordance with an embodiment of the present invention. Examples of such apparatus (500) include smart television (TV), smart phone, laptop, tablet, notebook, personal digital assistance (PDA), and desktop personal computer (PC). The apparatus (500) includes the various modules and units as described in FIG. 4 above.

In accordance with an embodiment of the invention, the apparatus (501) can be any electronic device having a web browsing application (502) (hereinafter referred to as browsing application) as an integral part. For the sake of brevity, only one browsing application is illustrated. It would be understood that the apparatus (501) can include a plurality of browsing applications. The browsing application (502) can be a web browser accessible on desktop, notebook, tablet, and laptop; or a mobile browser accessible on a mobile device such as smart phone and PDA. As described earlier, the browsing application (502) includes the browser module (403).

In addition, the apparatus (501) may include other applications (503) designed to provide various services/functionality to a user, with or without accessing data via a network. Examples of such applications include, but not limited to, music application, chat applications, mail applications, browser applications, messaging applications, e-commerce applications, social media applications, data based media applications, location-based service (LBS) applications, print/scan/fax applications, and search applications. Such applications can be either downloaded onto the apparatus (501) or preloaded in the apparatus (501).

Further, the apparatus (501) can include an offline storing module (504) for enabling storing, categorizing, displaying, and searching of offline stored content. The offline storing module (504) further includes the storing module (404), the detecting module (405), the fetching module (406), the categorization module (407), the rendering module (408), the comparator module (409), and the retrieving module (410). In one aspect of the invention, the offline storing module (504) and the other modules can be implemented within the browsing application (502) forming a part of the browser module (403). In another aspect of the invention, the offline storing module (411) and the other modules can be implemented separately from the browser module (403) within the browsing application (502). In one another aspect of the invention, the offline storing module (504) and the other modules can be implemented as part of an application available/installed on the apparatus (501). In such aspect, the application can be either downloaded on to the apparatus (501) or pre-stored in the apparatus (501)

The network environment (500) further includes a web-server or network host (505) communicatively coupled with apparatus (501) over a network (506). Examples of the network (506) include wireless network and wired network. The network host (505) provides a network host provided content or web content to the apparatus (501) via the browsing application (502) when a user is accessing the browsing application (502) to view one or more web pages. Examples of the network host provided content or the web content include, but not limited to, the web pages itself and documents obtained from the web pages such as PDF document, text document, presentation document, audio file, image file, video file, and animation file. The offline storing module (504) enables the apparatus (501) to store the network host provided content or the web content as an offline stored content for offline viewing at a plurality of non-host locations (506-1, 506-2, 506-3, 506-4, 506-5 . . . 506-N) (hereinafter referred to as non-host location (506) indicating one non-host location and non-host locations (506) indicating two or more non-host locations). In accordance with the invention, the non-host location (506) is a location independent of the network host (505). In one aspect of the invention, the non-host location (506) is communicatively coupled with the apparatus (501) over the network (506), as depicted in figure as non-host location (506-1) and non-host location (506-2). Examples of such networked non-host location include desktop, notebook, tablet, smart phone, laptop, and database. In addition, such networked non-host location can also include the browsing application (502), depicted in the figure as (506-2). In another aspect of the invention, the non-host location (506) is communicatively coupled with the apparatus (501) over a local network, as depicted in figure as non-host location (506-3), non-host location (506-4), and non-host location (506-N). Examples of such non-host location include desktop, notebook, tablet, smart phone, laptop, and local database. In one another aspect of the invention, the non-host location (506) is part of the apparatus (501). Examples of such non-host location include the browsing application (502) and the memory (411), depicted in the figure as (506-5).

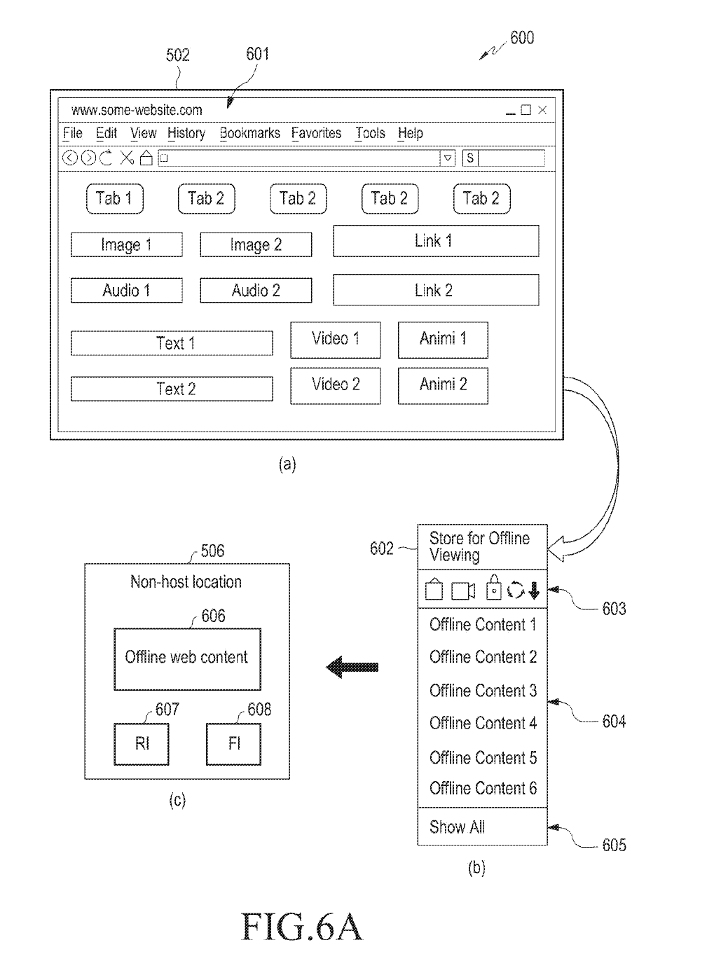

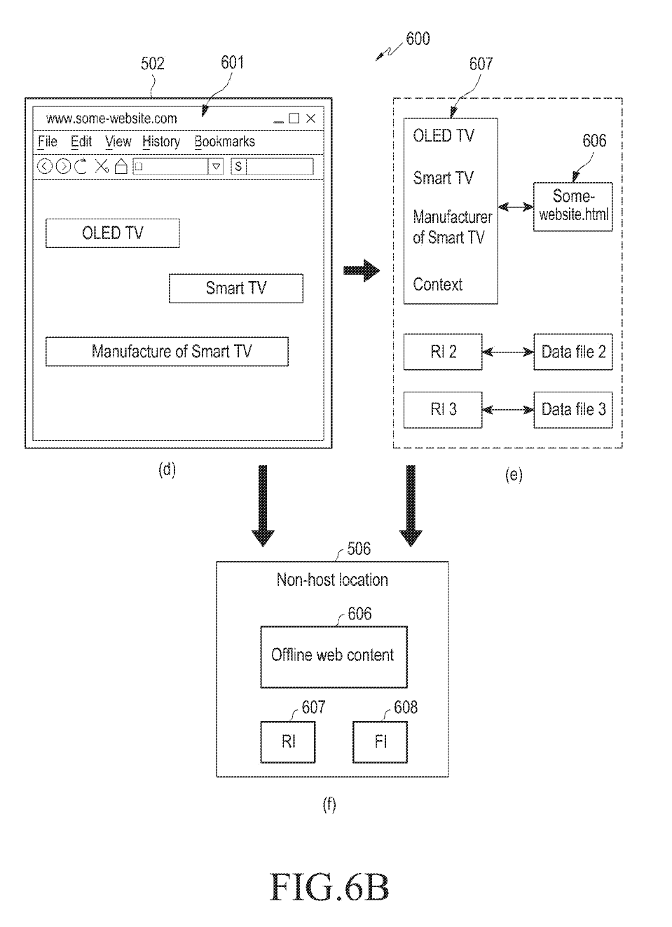

FIGS. 6A and 6B illustrates an example manifestation (600) of storing of network host provided content or web content at the non-host location (506) in the networked environment (500), in accordance with an embodiment of present invention. In operation, referring to a of FIG. 6A, the browsing application (502) receives network host provided content or web content from the network host (505). The web content is depicted on the display unit (402) of the apparatus (500) as webpage (601) and contents of the webpage (601) on a browser window of the browsing application (502). The webpage (601) includes various webpage elements such as videos, audio, animation, text, images, hyperlinks or navigational elements to other portions of webpage, and tabs. The tabs indicates links to extended web pages within the webpage (601). For example, the webpage (601) can be a homepage of an online newspaper and the tabs provide links to different sections of the online newspaper such as weather, sports, lifestyle, world news, domestic news, entertainment, travel, blogs, photos, and videos. In addition, the web page (601) can allow the web page elements and other documents for download such as PDF document, text document, presentation document, audio file, image file, video file, and animation file.

In accordance with the present invention, the offline storage module (504) provides a feature for storing the web content comprising of the webpage elements of the webpage (601) as an offline stored content. The feature can be provided in multiple ways such as an add-on feature of the browsing application (502), specific feature provided by an application installed on the apparatus (501), and an integrated feature of an operating system of the apparatus (501).

Consequently, a user provides a request to store the web content of the webpage (601) as offline content for offline viewing. The user can provide the request by one or more methods such as by:
clicking on saving or downloading option available on the browsing application (502);
clicking on saving or downloading option available on the webpage (601);
touching a specific icon available on the apparatus (501); and
clicking on add-ons available on the browsing application (502) such as ‘store for offline viewing’ option on right click on the webpage (601), ‘store for offline viewing’ option in menu bar of the webpage (601), and ‘store for offline viewing’ button in toolbar of the browsing application (502).

Accordingly, the browser module (403) receives the request to ‘store for offline viewing’ from the user. Upon receiving the request, as illustrated in (b) of FIG. 6A, the browser module (403) provides a user-interface (602) on the webpage (601) to the user. The user-interface (602) enables the user to select type of content for storing and subsequent offline viewing. In one implementation, as illustrated in (b) of FIG. 6A, the user-interface (602) may provide a plurality of options (603) that enable the user to select type of content for storing and subsequent offline viewing. The plurality of options (603) may include save only image, save only text, save only videos, save entire page, save in encrypted page, and save for auto refreshing in background mode. The user-interface (602) may further provide a listing (604) of prior stored offline web content for viewing. The listing (604) may include few of the prior stored offline web content in accordance with various parameters such as date, importance, and frequency of viewing. Further, the user-interface (602) may provide a link (605) for displaying all of the prior stored offline web content. Upon selecting the link (605), a further user-interface (not shown in the figure) may be provided that displays all of the prior stored offline web content. The displaying of the offline web content upon selecting from the listing (604) or from the further user-interface will be discussed in further paragraphs.

In another implementation, the user-interface (602) may provide a dropdown menu for selecting type of content for storing and subsequent offline viewing. In yet another implementation, the user-interface (602) may be a pop-up message indicating a preselected type of content for storing and subsequent offline viewing and providing a message to the user to accept or change the preselected type.

Upon receiving a selection of an option from the user-interface (602) corresponding to type of content for storing and subsequently offline viewing, the storage module (404) obtains retrieval information corresponding to the web content from the webpage (601), as illustrated in (c) of FIG. 6A. The retrieval information is information of searchable type based on the information present in the web content. The information of the searchable type can be obtained from the web content. The information of the searchable type comprise at least one of text information, image information, audio information, and video information. Such text information includes, but not limited to, complete text content, key words (all unique, all frequent, title, headings, bold, index), and keywords which have high probability of remembering by user. The information of the searchable type can also be obtained from context of the web content. Such text information includes, but not limited to, context of content, text synonyms, text searched by the user in the web content, text searched by the user before reaching the web page (601) and the web content, and text highlighted or marked by the user in the web content. The storage module (404) obtains the retrieval information from the webpage (601) using methods known in the art. In an example, the retrieval information can be obtained by analyzing Document Object Model (DOM) structure of the webpage (601). In another example, the retrieval information can be obtained by using an algorithm.

Further, the storage module (404) obtains further information or metadata information corresponding to the web content from the webpage (601). The further information or metadata information includes information related to the storage, information related to the content, information as obtained from the user, and combination thereof. The information related to the storage is information related to storing of the web content. Such information includes, but not limited to, date of storing the web content, time of storing the web content, and location of storing the web content. Similarly, the information related to the content is information related to the web content. Such information includes, but not limited to, size of the web content, title of the web content, link of the web content, type or format of the web content, source of the web content, address of the source of the web content, and metadata related to the web content. Further, the information as obtained from the user includes, but not limited to, details of the user such as login credentials, rating as provided by the user to the web content, number of times the web content has been viewed by the user and other users, and remarks as provided by the user to the web content. The storage module (404) obtains the further information or the metadata information from the webpage (601) using methods known in the art. In an example, the further information or the metadata information is obtained by analyzing Document Object Model (DOM) structure of the webpage (601). Further, in one aspect of the invention, the storage module (404) obtains the further information or the metadata information prior to storing the web content. In another aspect of the invention, the storage module (404) obtains the further information or the metadata information post the storing the web content.

Upon obtaining the retrieval information and/or the further information or the metadata information from the web content, the storage module (404) stores a data file corresponding to the selected type of web content as offline web content (606) at the non-host location (506). In an example, the data file is HTML file or XML file corresponding to the web page (601) and elements within the web page (601) such as audio file, image file, video file, and animation file. In another example, the data file is any document file such as PDF file, text file, and presentation file downloaded from the web page (601). In one another example, the storage module (404) stores the complete data file. In yet another example, the storage module (404) stores a modified data file.

Further, the storage module (404) selects the non-host location (506) based on the retrieval information and auto-stores the offline web content (606) at the non-host location (506). Accordingly, the storage module (404) analyses the retrieval information of the web content and creates a folder based on the retrieval information at the non-host location (506). Upon creating, the storage module (404) automatically saves the web content under the corresponding folders. In one aspect of the invention, the non-host location (506) is selected by the storage module (404) based storage parameters such as memory space, network bandwidth, and/or the metadata information. In one example, the storage module (404) may select the non-host location (506) as a device communicatively coupled with the apparatus (501) over a local network or the apparatus (501) itself. In such example, the storage module (404) may create a separate folder for storing the offline web content (606) at the device or in the memory (411) of the apparatus (501).

In addition, the storage module (404) avoids duplication of previously saved web content. Accordingly, the storage module (404) compares content of the previously saved web content with the new web content being saved. If content of the previously saved web content is same as content of the new web content being saved, the storage module (404) prevents saving of the new web content. The storage module (404) also provides a corresponding notification the user indicating the duplicity. Conversely, if content of the previously saved web content is different from content of the new web content being saved, the storage module (404) saves with new web content as a new version of the previously saved web content along with time and/or date of storing.

Further, the storage module (404) stores the web content in accordance with the option selected from the plurality of options (603). The storage module (404) obtains web content based on the selected option by analyzing Document Object Model (DOM) structure of the webpage (601). In an example, the selected option is ‘image only’. In such example, the storage module (404) parses the data file corresponding to the web page (601) and creates the DOM structure. The DOM structure provides a hierarchy of webpage elements of the webpage (601) in the form of nodes. Each node also holds other properties specific to the corresponding element of the webpage. The storage module (404) then traverses the DOM structure and fetches the images from the DOM structure. The storage module (404) then stores the fetched images at the non-host location (506). In addition, the storage module (404) creates or modifies the data file such that the parsing of the data file creates a DOM structure having details corresponding to the stored images.

Additionally, the storage module (404) may encrypt and password-protect the offline web content (606) to prevent unauthorized access to the offline web content (606). The storage module (404) encrypts the offline web content (606) using standard cryptographic techniques. Thus, when the user tries to open the offline web content (606), the user is prompted to provide a password. The password is then used to decrypt the offline web content (606) and presented to the user.

In addition to saving the web content for offline viewing, the user may also select the option of ‘auto-refresh’. Accordingly, once the web content is stored as the offline web content (606), the browser module (403) sends request for content to the network host (505) at predetermined time intervals and upon satisfying predetermined conditions. Upon receiving the request, the network host (505) transmits data file corresponding to the web page (601). The browser module (403) then compares the received data file with the saved data file or the offline web content (606) and updates the content based on the comparison. Further, the storage module (404) stores the retrieval information as retrieval information (RI) (607) in a mapped relationship with the offline web content (606). Similarly, the storage module (404) stores the further information or the metadata information as further information (FI) (608) at the non-host location (506) in a mapped relationship with the offline web content (606). Thus, retrieval information (607) and the further information (608) include data mapping to or pointing to the corresponding offline web content (606). In an example, the retrieval information (607) and the further information (608) are stored in the form of a table. In another example, the retrieval information (607) and the further information (608) are stored in the form of a data file such as text file and comma separated value (CSV) file. Further, in one aspect of the invention, the storage module (404) stores the retrieval information (607), the further information (608), and the offline web content (606) at same location, as depicted in the (c) of FIG. 6A. In another aspect of the invention, the storage module (404) stores retrieval information (607), the further information (608), and the offline web content (606) at different locations. In an example, the retrieval information (607) and the further information (608) are stored within the browsing application (502) and the offline web content (606) is stored in a device coupled to the apparatus (501).

The above description cab be better understood, by referring to (d), (e), and (f) of FIG. 6B. As illustrated in (d) of FIG. 6B, the web page (601) having link ‘some-website.com’ includes content and contest related to smart TV and display technology of smart TV. Accordingly, the storage module (404) obtains the retrieval information (607) by identifying keywords such as ‘OLED TV’, ‘Smart TV’, and ‘Manufacturer of Smart TV’ from the web page (601). In addition, the storage module (404) may obtain the further information or metadata (608) from the web page (601).

As illustrated in (e) of FIG. 6B, the storage module (404) creates a mapped relationship between the retrieval information (607) and the offline web content (606) (represented by a left-right arrow). In addition, the storage module (404) may create a mapped relationship between the further information (608) and the offline web content (606) (not shown in the figure). The mapped relationship can be created based on one or more predefined rules, and mapping algorithms as known in the art. Such a mapping between the retrieval information (607), the further information (608), and the offline web content (608) can include any mapping combination such as one-to-one mapping, one-to-many mapping, many-to-one mapping, many-to-many mapping, and any combination thereof. For the sake of brevity, one-to-one mapping relationship between a data file corresponding to the relevant information and a data file corresponding to the offline web content is illustrated in the figure using a left-right arrow.

As illustrated in (f) of FIG. 6B, the storage module (404) stores the retrieval information (607) and the offline web content (606) at the non-host location (506). In addition, the storage module (404) may store the further information (608) at the non-host location (506). Since the retrieval information (607), the further information (608), and the offline web content (606) are stored in a mapped relationship, the retrieval information (607) and the further information (608) includes data mapping to or pointing to the corresponding offline web content (606).

Furthermore, in a similar manner, the user can select plurality of web pages and/or web content from the plurality of web pages for storing and subsequent offline viewing. Upon receiving the selection, the storage module (404) obtains retrieval information and/or metadata information from web content of each of the plurality of web pages. Upon obtaining the information, the storage module (404) stores the multiple web pages and/or the web content as the offline web content (606) and the retrieval information corresponding to each of the plurality of web pages and/or the web content as the retrieval information (607) in a mapped relationship at the non-host location (506).

Upon storing the web page (601) at the non-host location (506), the offline web content (606) is displayed to the user after categorization of the offline web content (606). In one aspect of the invention, the user is provided with a graphical user-interface to categorize the offline web content (606). Accordingly, the user can provide a category such as news, sports, food, art, and finance. In another aspect of the invention, the categorization is performed automatically. Accordingly, the detecting module (405) detects availability of the offline web content (606) at the non-host location (506). In an example, the detecting module (405) scans the non-host location (506) for any offline web content being saved in the non-host location (506). Upon detecting the availability of the offline web content (606), the fetching module (406) fetches the retrieval information (607) corresponding to the offline web content (606) from the non-host location (506). Similarly, the fetching module (506) may also fetch the further information or the metadata information (608) from the non-host location (506). In one aspect of the invention, the fetching module (506) only fetches the retrieval information (607). In another aspect of the invention, the fetching module (506) fetches both the retrieval information (607) and the metadata information (608).

Upon fetching the retrieval information, the categorization module (407) categorizes the offline web content (606) based the retrieval information and one or more predefined categorization rules. Accordingly, the categorization module (407) identifies one or more attributes from the retrieval information based on the predefined categorization rules. Examples of the attributes include, but not limited to, category of the web content, subject matter of the web content, time of storing the web content, and location of storing the web content. Examples of the categorization rules include, but not limited to, categorize or classify the offline web content in accordance with the subject matter of the content. Similarly, upon fetching the further information, the categorization module (407) categorizes the offline web content (606) based the further information and one or more predefined categorization rules. Accordingly, the categorization module (407) identifies one or more attributes from the further information based on the predefined categorization rules. In one aspect of the invention, the categorization module (407) categorizes the offline web content (606) based on the retrieval information (607) only. In another aspect of the invention, the categorization module (407) categorizes the offline web content (606) based on both the retrieval information (607) and the metadata information (608).

Upon categorizing the offline web content (606), the rendering module (408) displays information of the offline web content (606) in a graphical user interface in accordance with the categorization. In one example, the graphical user interface is a new tab or new instance of the browsing application (401). In another example, the graphical user interface corresponds to a setting page of the browsing application (401). In yet another example, the graphical user interface is similar to a bookmark interface of the browsing application (401).

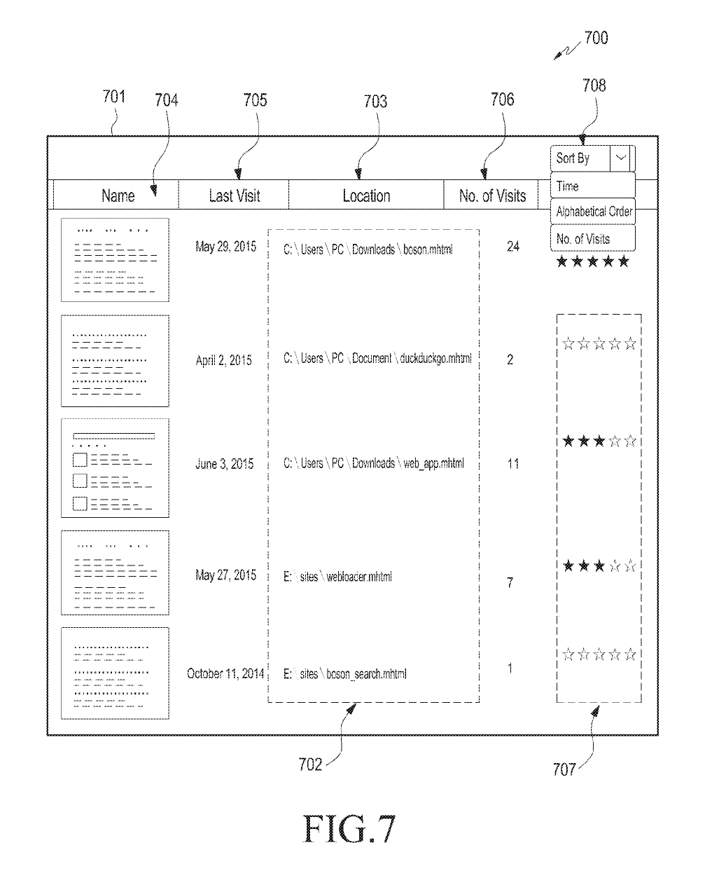

FIG. 7 illustrates a first example manifestation (700) of displaying offline web content, in accordance with an embodiment of present invention. The example manifestation (700) includes user interface (701) displaying information (702) about offline web content. In an example, the user interface (701) is a new tab or new instance of the browsing application (401). In another example, the user interface (701) corresponds to a setting page of the browsing application (401). The information (702) about offline web content includes a location (703) of stored or offline web content corresponding to a plurality of web pages. A preview (704) of the web content is shown along with last visited date (705), number of visits (706) indicative of frequency of visiting the corresponding web page, and user rating (707). In addition, the user-interface (701) also provides a sorting option (708) to sort information (702) about offline web content based on various parameters such as time visited, user rating, number of visits, and alphabetical order.

Further, in the example, the location (703) is local storage area of device providing the user-interface (701). Accordingly, in the present first example manifestation, categorization module (407) categorizes the offline web content based on the location (703) the offline in alphabetical order of the name of location (703). Upon categorization, the rendering module (408) displays the information (702) about offline web content on the user-interface (701) in accordance with the categorization.

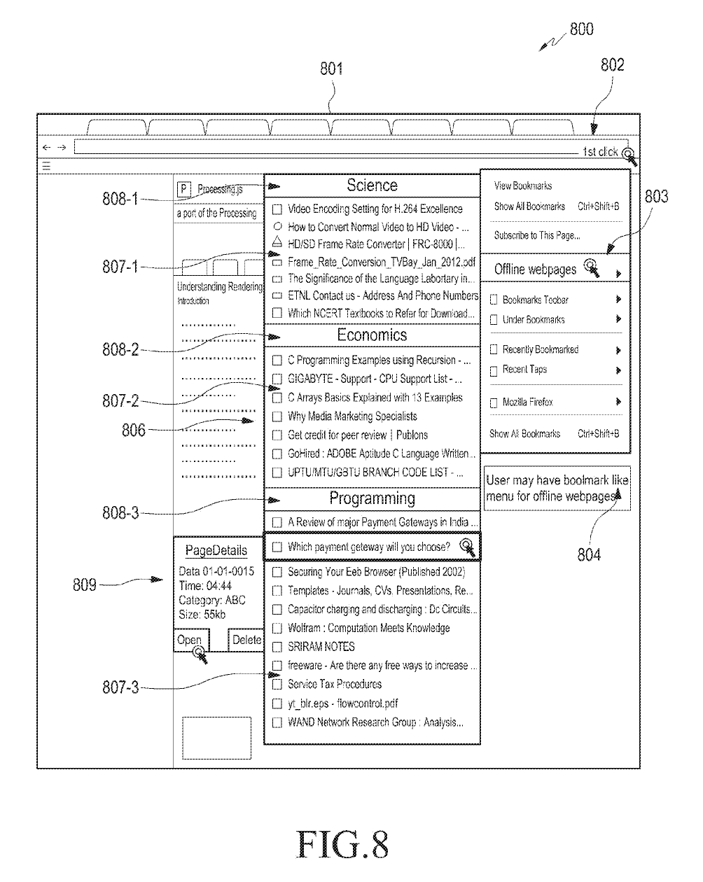

FIG. 8 illustrates a second example manifestation (800) of displaying offline web content, in accordance with an embodiment of present invention. In such manifestation, information about offline web content can be listed in a manner similar to a bookmark interface of the browsing application (401). Accordingly, user interface (801) corresponding to the browsing application (401) provides a ‘bookmark’ feature (802). In present manifestation, the user-interface (801) is a new tab of the browsing application (401). In other manifestation, the user-interface (801) is a previously opened tab of the browsing application (401). In one another manifestation, the user-interface (801) is a new instance of the browsing application (401). As such, upon selecting the ‘bookmark’ feature (802) available on the browsing application (401), a second user-interface (803) is displayed. In an example, the second user-interface (803) is overlaid on the first user-interface (801). The second user-interface (803) lists various options available under ‘bookmark’ such as show all bookmarks, bookmark toolbar, recently bookmarked, and tags. Along with the various options, a feature (804) corresponding to ‘offline web pages’ in provided in the second user-interface (803). Upon clicking on the feature (804) corresponding to ‘offline web pages’, a third user-interface (805) is displayed. In an example, the third user-interface (804) is overlaid on the first user-interface (801).

The third user-interface (804) displays information (806) about offline web content. The information (806) about offline web content includes title of plurality of web pages saved as the offline web content and categorized under different categories. In the present first example manifestation, the categorization module (407) identifies ‘subject matter of the web content’ as an attribute for categorization from the retrieval information. Accordingly, the categorization module (407) identifies ‘science’, ‘economy’, and ‘programming’ as ‘subject matter of the web content’ from the retrieval information. Upon identifying, the categorization module (407) categorizes the offline web content under the identified groups. In the example, a first set (807-1) of web pages are grouped under first category (808-1), namely ‘science’. Similarly, a second set (807-2) of web pages are grouped under second category (808-2), namely ‘economy’. Similarly, a third set (807-3) of web pages are grouped under third category (808-3), namely ‘programming’. Upon categorization, the rendering module (408) displays the information (806) about offline web content on the user-interface (804) in accordance with the categorization. As would be understood, the categorization is performed before displaying the user-interface (804). Upon selecting a web page from the third user-interface (804), a further user-interface (809) is displayed enabling the user to open the selected webpage.

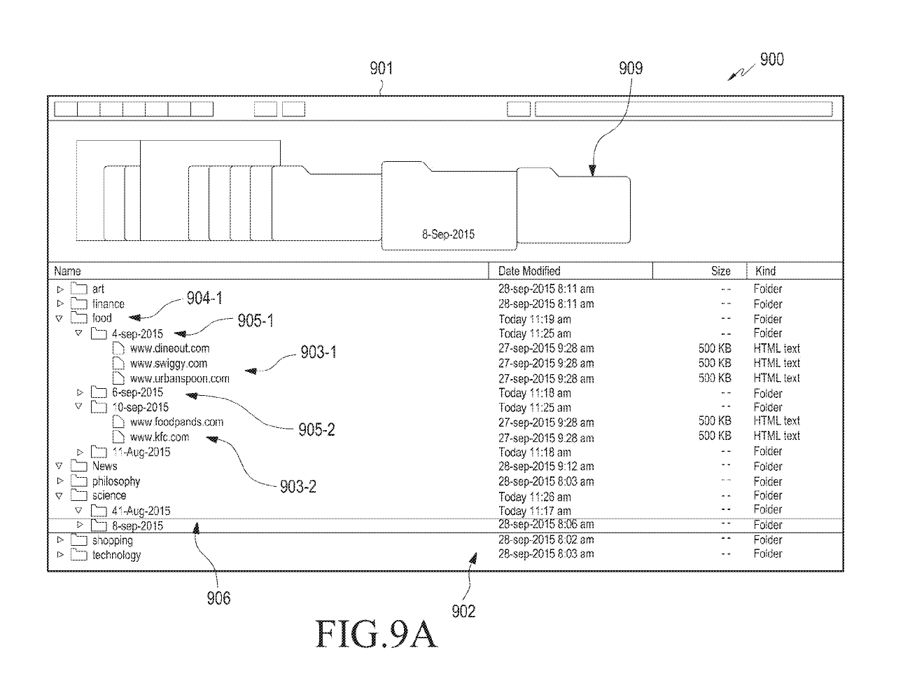

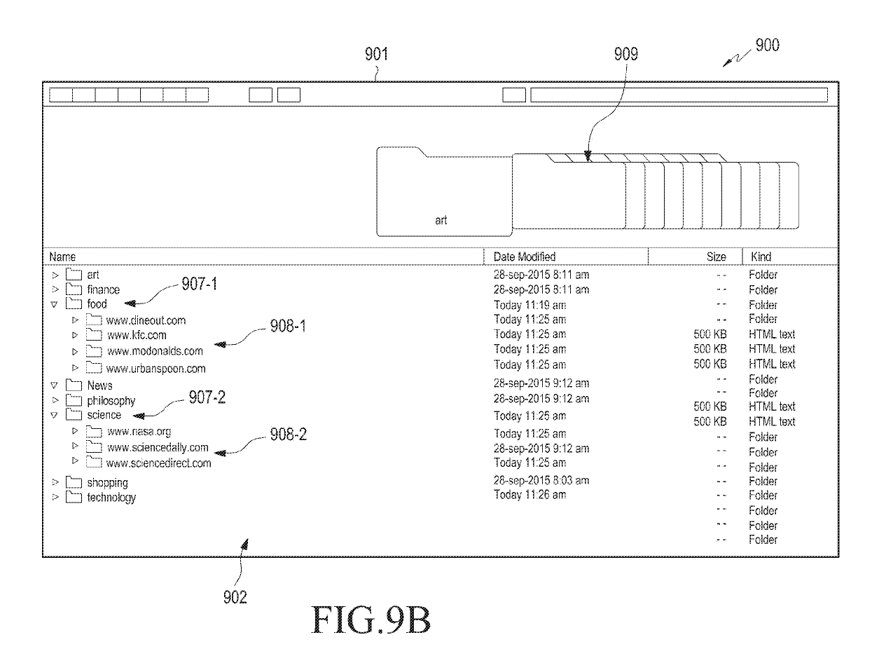

FIGS. 9A and 9B illustrate a third example manifestation (900) of displaying offline web content, in accordance with an embodiment of present invention. In such manifestation, information about offline web content can be listed by accessing ‘Favourites’ folder of the apparatus (501). The ‘Favourites’ folder lists down folders for quick access without having to navigate through a folder tree of the apparatus (501). The folders can be available on the apparatus (501) itself or on any other device.

As illustrated in FIGS. 9A and 9B, user-interface (901) is displayed upon accessing the ‘Favourites’ folder. The user-interface (901) displays information (902) about offline web content. The information (902) about offline web content includes title of plurality of web pages saved as the offline web content. In the present manifestation, the offline web content is auto/intelligently saved under different categories and displayed to the user. Accordingly, the storage module (404) obtains the retrieval information of the offline web content and creates a folder based on the retrieval information in the apparatus (501) or on any other device. Upon creating, the storage module (404) automatically saves the offline web content under the corresponding folders.

In one example implementation, the storage module (404) obtains the retrieval information of the offline web content and identifies a primary category as ‘subject matter of the content’ or ‘context of the content’ and a sub-category as ‘date of saving the content’. Upon identifying, the storage module (404) creates folder corresponding to the categories and automatically saves the web content in respective folders. As illustrated in FIG. 9A, a first set (903-1) of web pages as web content are auto-saved under first primary category or folder (904-1), namely ‘food’, and first sub-category or folder (905-1), namely 4 Sep. 2015. Similarly, a second set (903-2) of web pages as web content are auto-saved under the first primary category (904-1), namely ‘food’ and second sub-category or folder (905-2), namely 10 Sep. 2015. Similarly, the storage module (404) creates other primary folders such as art, finance, science, shopping, and adds sub-folders in the primary folder.

Further, in the example, upon receiving a request to save a web content related to a scientific principle on 6 Sep. 2015, the storage module (404) retrieves the retrieval information and identifies the primary category as ‘science’ and a sub-category as ‘6 Sep. 2015’. The storage module (404) then creates a sub-folder, namely 6 Sep. 2015′ under the primary folder ‘science’, which already includes a sub-folder, namely ‘4 Aug. 2015’. Upon creation, the storage module (404) automatically saves the web content in respective folders (illustrated using reference numeral 906).

In another example implementation, the storage module (404) obtains the retrieval information of the offline web content and identifies a primary category as ‘subject matter of the content’ or ‘context of the content’ and a sub-category as ‘links to the web pages’. Upon identifying, the storage module (404) creates folder corresponding to the categories and automatically saves the web content in respective folders. As illustrated in FIG. 9B, a first set of web pages are grouped under primary category or folder (907-1), namely ‘food’ and sub-category or folder as link of the web pages (908-1). Similarly, a second set of web pages are grouped under second primary category (907-2), namely ‘science’ and sub-category or folder as link of the web pages (908-2).

Further, in the example, upon receiving a request to save a web content related to a modern art, the storage module (404) retrieves the retrieval information and identifies the primary category as ‘art’. The storage module (404) then creates a sub-folder under the primary folder ‘art’ corresponding to link of the web content. Upon creation, the storage module (404) automatically saves the web content in respective folders.

In addition, the user-interface (901) displays bar (909) indicating a structure of folders created for storing the plurality of web pages as the offline web content. Thus, in the FIG. 9(a), the bar (909) illustrates the latest folder ‘science’ being accessed upon saving the web content related to a scientific principle. Similarly, in the FIG. 9(b), the bar (909) illustrates the latest folder ‘art’ being accessed upon saving the web content related to a modern art.

Further, the storage module (404) maps retrieval information with the offline web content as described earlier. Upon saving the offline web content, the rendering module (408) can display information about the offline web content. In one example, the rendering module (408) can display information by using the same user-interface (901). In another example, the rendering module (408) can display information by using a user-interface different from the user-interface (901), as illustrated in FIGS. 7 and 8. In addition, the rendering module (408) may display other parameters such as date of storing, type of web content, and size of the web content.

Thus, the above example manifestations illustrate the manner in which the apparatus (501) categorizes the offline web content (606) according to different categorization rules and retrieval information and displays the offline web content (606) at a single place to the user for viewing or accessing. Further, the above example manifestations illustrate the manner in which the apparatus (501) auto-saves the offline web content (606) according to retrieval information in different folders and displays the offline web content (606) at a single place to the user for viewing or accessing. In addition, the user can customize the display of the offline web content (606) on the user-interface. In an example, the user can customize the display via a setting page of the browser application (502). Examples of the customization include, but not limited to, selectively displaying offline content based on freshness of content, selectively displaying offline content based user-interest such as related to specific subject matter and specific industry, and selectively displaying offline content based window size of user-interface.

Upon receiving a selection of web page from the user-interface, as mentioned in above figures, the fetching module (406) fetches the retrieval information (607) from the non-host location (506) corresponding to the selected webpage. Upon obtaining the retrieval information (607), the fetching module (406) fetches the data file corresponding to the selected web page from the offline web content (606) based on the mapped relationship. The rendering module (408) then displays the selected web page in accordance with the fetched data file in the browsing application (401). In an example, the rendering module (408) displays the web page in the first browsing interface (801). In another example, the rendering module (408) displays the web page in the new tab or new instance of the browsing application (401).

Further, upon saving of the offline web content (606), in addition to categorizing and displaying the offline web content, the apparatus (501) allows the user to search for the offline web content (606) based on the retrieval information mapped with the offline web content (606).

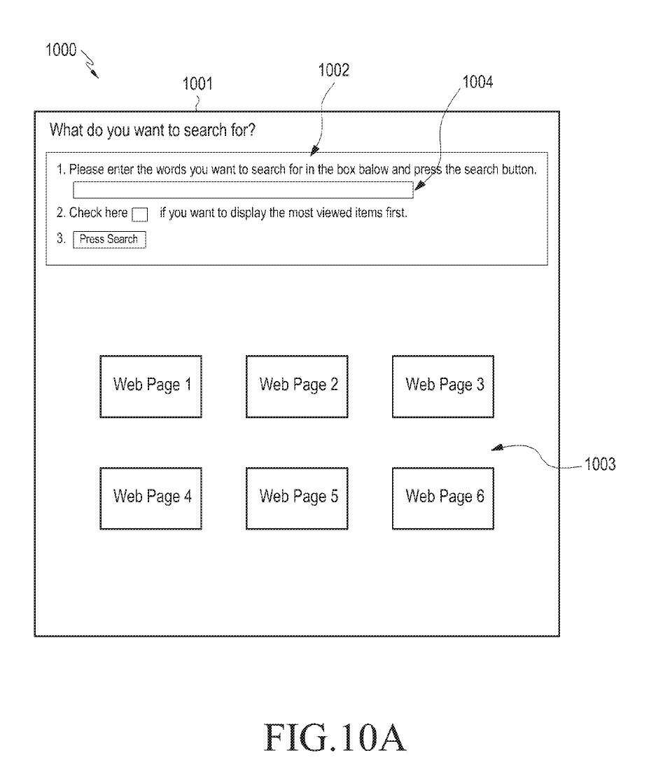

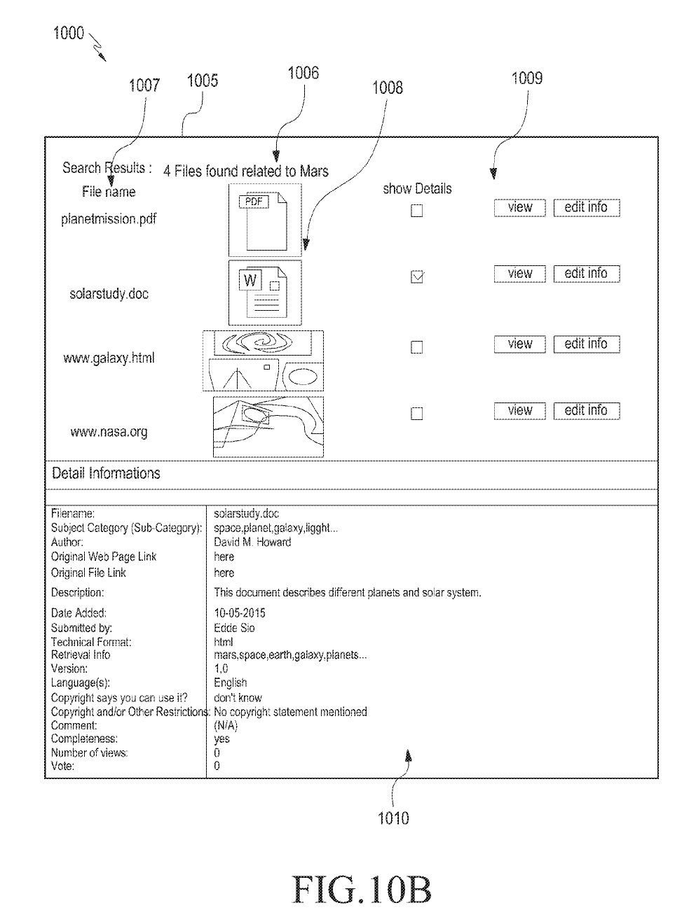

FIGS. 10A and 10B illustrate a first example manifestation (1000) of searching of offline web content (606), in accordance with an embodiment of present invention. In the example, as illustrated in FIG. 10A, the apparatus (501) provides a user interface (1001) within the browser application (502). The user interface (1001) is displayed upon opening new tab within the browser application (502) or new instance of the browser application (502).

The user-interface (1001) includes a first portion (1002) and a second portion (1003). The second portion (1003) provides a list of web pages for quick access, arranged in a grid structure. In one example, the list of web pages are displayed based on recent visit. In another example, the list of web pages correspond to the offline web content displayed based on user customization. The first portion (1002) is configured to receive at least one search criterion for searching of offline web content (606), in accordance with the invention. Consequently, the first portion (1002) includes a text field (1004) for receiving text data indicating the search criterion. The search criterion can be based on the retrieval information. As described earlier, retrieval information includes, but not limited to, complete text content, and key words. Similarly, in another aspect of the invention, search criterion can be based on the retrieval information and additionally the further information or the metadata information. As described earlier, the metadata information includes, but not limited to, date of storing the web content, time of storing the web content, location of storing the web content, size of the web content, title of the web content, link of the web content, type or format of the web content, source of the web content, address of the source of the web content, metadata related to the web content, rating as provided by the user to the web content, number of times the web content has been viewed by the user and other users, and remarks as provided by the user to the web content. The search criterion is received by the browsing module (403) and is provided to the fetching module (406) for further processing.

Upon receiving the search criterion, the fetching module (406) fetches the retrieval information (607) from the non-host location (506). In an example, the fetching module (406) may fetch the retrieval information (607) from all non-host locations (506). Upon fetching the retrieval information (607), the comparator module (407) compares the received search criterion with the retrieval information (607). Based on the comparison, the comparator module (407) identifies a portion of the retrieval information (607) that matches with the received search criterion. The retrieving module (410) then retrieves offline web content (606) from the non-host location (506) based on the identified portions and the mapped relationship between the retrieval information (607) and the offline web content (606). Thus, the apparatus (501) only searches for the retrieval information and not the entire files or offline web content (606) stored at the non-host location (506). In addition, the offline web content (606) can be retrieved based on the further information or the metadata information (608). Thereafter, the rendering module (408) displays information of the retrieved offline web content (606) in a user-interface within the browser application (502).

FIG. 10B illustrates a user-interface (1005) displaying information of the retrieved offline web content (606), as described in FIG. 10(a). The user-interface (1005) can be a new user-interface opened in a new tab within the browser application (502) or a new instance of the browser application (502). In one example, the rendering module (408) may display the user-interface (1005) upon retrieving the offline web content (606) in response to the search criterion. In another example, the rendering module (408) may display the user-interface (1005) immediately after receiving the search criterion.

The user-interface (1005) depicts number (1006) of files corresponding to the web content retrieved based on the search criterion. Examples of the web content include, but not limited to, the web page itself and document obtained from the web page such as PDF document, text document, presentation document, audio file, image file, video file, and animation file. Therefore, the corresponding files can include, but not limited to, HTML file or XML file corresponding to the web page, audio file, image file, video file, animation file, PDF file, text file, and presentation file.

Further, the user-interface (1005) depicts name (1007) of the files along with a preview (1008) of the files. In one example, the preview (1008) of the files depicts an icon corresponding to format of the file such as word, web page, image, video, animation, and PDF. Further, the user-interface (1005) depicts a plurality of options (1009) along with the preview (1008) of the files. The plurality of options (1009) enables the user to view or edit details of the retrieved files. The plurality of options (1009) include, but not limited to, ‘show details’ of the retrieved files, ‘edit details’ of the retrieved files, and ‘view’ the retrieved files. Upon selecting ‘show details’ from the plurality of options (1009), the rendering module (408) displays the details of the selected file from the retrieval information (607) in a further portion (1010) of the user-interface (1005).

Further, as described earlier, upon selecting ‘view’ from the plurality of options (1009), the fetching module (406) fetches the data file corresponding to the selected file from the offline web content (606). The rendering module (408) then displays the selected web page in accordance with the fetched data file in the browsing application (401).

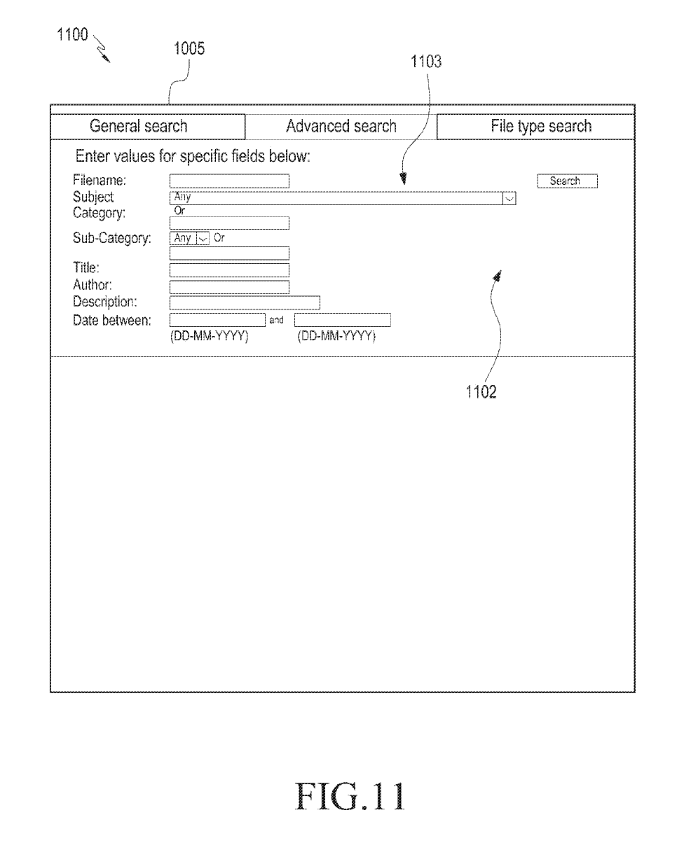

Similarly, FIG. 11 illustrates a second example manifestation (1100) of searching of offline web content (606), in accordance with an embodiment of present invention. In the example, as illustrated in FIG. 11, the apparatus (501) provides a user interface (1101) within the browser application (502). The user interface (1101) can be displayed upon opening new tab within the browser application (502) or new instance of the browser application (502).

The user-interface (1101) includes a first portion (1002) and a second portion (not shown in the figure), similar to the second portion (1004) of the user-interface (1001) as illustrated in FIG. 10. The first portion (1102) is configured to receive at least one search criterion for searching of offline web content (606). The first portion (1102) can be termed as ‘Advance Search’ feature. Consequently, the first portion (1002) includes a plurality of text fields (1103) for receiving text data indicating the search criterion. Examples of the plurality of text fields (1103) include, but not limited to, file name, subject, category, sub-category, title, author, description, and date of saving the web content. The search criterion can be based on the retrieval information. As described earlier, retrieval information includes, but not limited to, complete text content, and key words. Similarly, in another aspect of the invention, search criterion can be based on the retrieval information and additionally the further information or the metadata information. As described earlier, the metadata information includes, but not limited to, date of storing the web content, time of storing the web content, location of storing the web content, size of the web content, title of the web content, link of the web content, type or format of the web content, source of the web content, address of the source of the web content, metadata related to the web content, rating as provided by the user to the web content, number of times the web content has been viewed by the user and other users, and remarks as provided by the user to the web content.

As described earlier, upon receiving the search criterion, the fetching module (406) fetches the retrieval information (607) from the non-host location (506). Upon fetching the retrieval information (607), the comparator module (407) compares the received search criterion with the retrieval information (607). Based on the comparison, the comparator module (407) identifies a portion of the retrieval information (607) that matches with the received search criterion. The retrieving module (410) then retrieves offline web content (606) from the non-host location (506) based on the identified portions and the mapped relationship between the retrieval information (607) and the offline web content (606). As described earlier, such a mapping between the retrieval information (607) and the offline web content (608) can include any mapping combination such as one-to-one mapping, one-to-many mapping, many-to-one mapping, many-to-many mapping, and any combination thereof. Thus, the apparatus (501) only searches for the retrieval information and not the entire files or offline web content (606) stored at the non-host location (506). In addition, the offline web content (606) can be retrieved based on the further information or the metadata information (608). Thereafter, the rendering module (408) displays information of the retrieved offline web content (606) in a user-interface within the browser application (502).

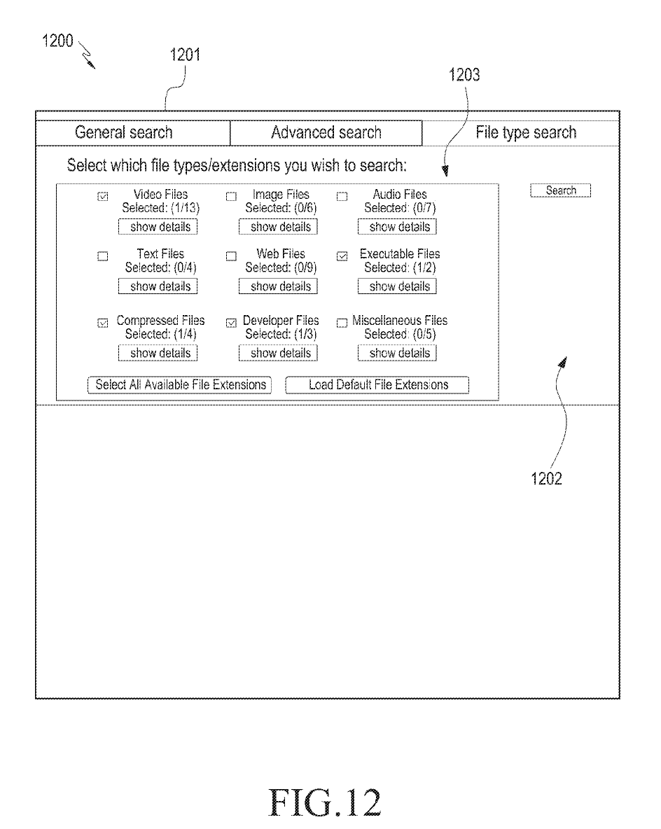

Likewise, FIG. 12 illustrates a third example manifestation (1200) of searching of offline web content (606), in accordance with an embodiment of present invention. In the example, as illustrated in FIG. 12, the apparatus (501) provides a user interface (1201) within the browser application (502). The user interface (1201) can be displayed upon opening new tab within the browser application (502) or new instance of the browser application (502).

The user-interface (1201) includes a first portion (1202) and a second portion (not shown in the figure), similar to the second portion (1004) of the user-interface (1001) as illustrated in FIG. 10. The first portion (1202) is configured to receive at least one search criterion for searching of offline web content (606). The first portion (1202) can be termed as ‘File Type Search’ feature. Consequently, the first portion (1202) includes a plurality of file type options (1203) for selecting a file type as the search criterion. Examples of the plurality of text fields (1203) include, but not limited to, video, image, audio, text, web file, executable file, developer file, compressed file, and miscellaneous file, all available, and default file extension.

As described earlier, upon receiving the search criterion, the fetching module (406) fetches the retrieval information (607) from the non-host location (506). In the present example, the fetching module (406) also retrieves the further information or the metadata information (608) to identify the file type. Upon fetching the retrieval information (607) and the further information (608), the comparator module (407) compares the received search criterion with the retrieval information (607) and the further information (608). Based on the comparison, the comparator module (407) identifies a portion of the retrieval information (607) and the further information (608) that matches with the received search criterion. The retrieving module (410) then retrieves offline web content (606) from the non-host location (506) based on the identified portions and the mapped relationship between the retrieval information (607), the further information (608), and the offline web content (606). Thus, the apparatus (501) only searches for the retrieval information and the further information and not the entire files or offline web content (606) stored at the non-host location (506). Thereafter, the rendering module (408) displays information of the retrieved offline web content (606) in a user-interface within the browser application (502).

Thus, the above example manifestations illustrate the manner in which the apparatus (501) provides various options for searching the offline web content (606) based on the retrieval information and/or the further information without having the need to know the exact location of the non-host location (506).

Further, the present invention obtains retrieval information from the web content being stored and stores the retrieval information in a mapped relationship with the web content. Based on the retrieval information, the web content is auto-saved to local folders in the non-host location without providing exact location of storage. Additionally, the web content is auto-classified and corresponding folders are created based on the retrieval information. Therefore, the web content is automatically stored at a dynamic location, which is more likely a place where the user would save the web content manually. This eliminates the need for manual saving or saving at a predefined static location.

Furthermore, the retrieval information enables efficient classification of the offline web content and displays the classified offline web content on a user-interface corresponding to a browser application. In addition, any change in location of the offline web content is automatically updated in the user-interface. The display of categorized or classified offline web content on the browser application is based on user interest. Such a display allows the user to open the offline web content directly on the browser application without having to know or traversing to the exact storage location of the offline web content on the non-host location.

Furthermore, the retrieval information enables searching of the offline web content from any location or any device different from the host without having to remembering exact storage location of the offline web content. In addition, the retrieval information enables efficient searching of the offline web content based on context of the content and content itself, which is likely to be remembered by the user. Furthermore, the user can search amongst multiple saved offline content based on context of the content and content itself. This avoids the conventional long process of traversing the storage location of the offline web content, for example, entire memory or hard drive of a device, for the offline content and opening the offline content from that location.

### Exemplary Implementaiton

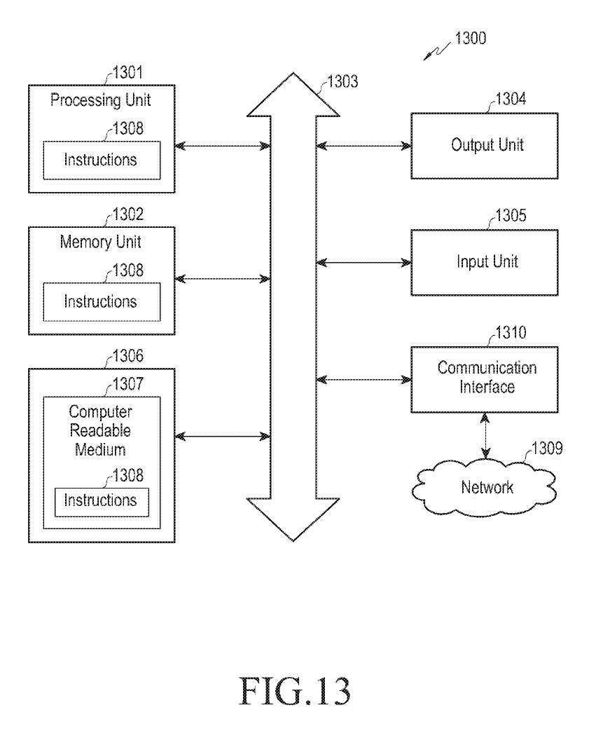

FIG. 13 illustrates a typical hardware configuration of an apparatus (1300), wherein various embodiments of invention can be implemented. The apparatus (1300) can be any system having a gesture based user interface and which is capable of in terms of software and hardware for receiving touch or air based user inputs. Typical examples of the apparatus (1300) include, but are not limited a mobile phone, tablet, gaming device, laptop, desktop computer, PDA, television, ATM, ticketing machines, consumer appliances, etc. The apparatus (1300) can include a set of instructions that can be executed to cause the apparatus (1300) to perform any one or more of the methods, in accordance with the invention. The apparatus (1300) may operate as a standalone device or may be connected, for example, using a network to other computing systems or peripheral devices.

In a networked deployment, the apparatus (1300) may operate in the capacity of a server or as a client user computer in a server-client user network environment, or as a peer computing system in a peer-to-peer (or distributed) network environment. The apparatus (1300) can also be implemented as or incorporated into a variety of devices, which are capable of executing a set of instructions (sequential or otherwise) that specify actions to be taken by that device. Furthermore, while a single apparatus (1300) is illustrated in the figure, the term “system” shall also be taken to include any collection of systems or sub-systems that individually or jointly execute a set, or multiple sets, of instructions to perform one or more computer functions.

The apparatus (1300) may include a processing unit (1301) e.g., a central processing unit (CPU), a graphics processing unit (GPU), or both. The processing unit (1301) may be a component in a variety of systems. For example, the processing unit (1301) may be part of a standard personal computer or a workstation. The processing unit (1301) may be one or more general processors, digital signal processors, application specific integrated circuits, field programmable gate arrays, servers, networks, digital circuits, analog circuits, combinations thereof, or other now known or later developed devices for analysing and processing data. The processing unit (1301) may implement a software program, such as code generated manually (i.e., programmed).

The apparatus (1300) may include a memory unit (1302), such as a memory unit (1302) that can communicate via a bus (1303). The memory unit (1302) may be a main memory, a static memory, or a dynamic memory. The memory unit (1302) may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory unit (1302) includes a cache or random access memory for the processing unit (1301). In alternative examples, the memory unit (1302) is separate from the processing unit (1301), such as a cache memory of a processor, the system memory, or other memory. The memory unit (1302) may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory unit (1302) is operable to store instructions executable by the processing unit (1301). The functions, acts or tasks illustrated in the figures or described may be performed by the programmed processing unit (1301) executing the instructions stored in the memory unit (1302). The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the apparatus (1300) may or may not further include an output unit (1304), such as an audio unit and/or a display unit. The examples of the display unit include, but are not limited to a liquid crystal display (LCD), an organic light emitting diode (OLED), a flat panel display, a solid state display, a cathode ray tube (CRT), a projector, a printer or other now known or later developed display device for outputting determined information. The output unit (1304) may act as an interface for the user to listen/see the functioning of the processing unit (1301), or specifically as an interface with the software stored in the memory unit (1302) or in a removable storage device. Additionally, the apparatus (1300) may include an input unit (1305) configured to allow a user to interact with any of the components of system (300). The input unit (1305) may be a number pad, a keyboard, or a cursor control device, such as a mouse, or a joystick, remote control or any other device operative to interact with the apparatus (1300). Sometimes, a single IO unit, such a touch screen display, can serve the function of the output unit (1304) as well as the input unit (1305).

The apparatus (1300) may also include a disk or optical drive unit (1306). The disk drive unit (1306) may include a computer-readable medium (1307) in which one or more sets of instructions (1308), e.g. software, can be embedded. Further, the instructions (1308) may embody one or more of the methods or logic as described. In a particular example, the instructions (1308) may reside completely, or at least partially, within the memory unit (1302) or within the processing unit (1301) during execution by the apparatus (1300). The memory unit (1302) and the processing unit (1301) also may include computer-readable media as discussed above.

The present invention contemplates a computer-readable medium that includes instructions (1308) or receives and executes instructions (1308) responsive to a propagated signal so that a device connected to a network (1309) can communicate voice, video, audio, images or any other data over the network (1309). Further, the instructions (1308) may be transmitted or received over the network (1309) via a communication port or interface (1310) or using the bus (1303). The communication port or interface (1310) may be a part of the processing unit (1301) or may be a separate component. The communication port or interface (1310) may be created in software or may be a physical connection in hardware. The communication port or interface (1310) may be configured to connect with the network (1309), external media, the output unit (1304), or any other components in the apparatus (1300) or combinations thereof. The connection with the network (1309) may be a physical connection, such as a wired Ethernet connection or may be established wirelessly as discussed later. Likewise, the additional connections with other components of the system (300) may be physical connections or may be established wirelessly. The network (1309) may alternatively be directly connected to the bus (1303).

The network (1309) may include wired networks, wireless networks, Ethernet AVB networks, or combinations thereof. The wireless network may be a cellular telephone network, an 802.11, 802.16, 802.20, 802.1Q or WiMax network. Further, the network (1309) may be a public network, such as the Internet, a private network, such as an intranet, or combinations thereof, and may utilize a variety of networking protocols now available or later developed including, but not limited to TCP/IP based networking protocols.

In an alternative example, dedicated hardware implementations, such as application specific integrated circuits, programmable logic arrays and other hardware devices, can be constructed to implement various parts of the apparatus (1300).

The present invention can be implemented on a variety of electronic and computing systems. For instance, one or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

Any one or more of the methods or logic as described may be implemented in part by software programs executable by a computing system. Further, in a non-limited example, implementations can include distributed processing, component/object distributed processing, and parallel processing. Alternatively, virtual computing system processing can be constructed to implement various parts of the apparatus (1300).

The apparatus (1300) is not limited to operation with any particular standards and protocols. For example, standards for Internet and other packet switched network transmission (e.g., TCP/IP, UDP/IP, HTML, HTTP) may be used. Such standards are periodically superseded by faster or more efficient equivalents having essentially the same functions. Accordingly, replacement standards and protocols having the same or similar functions as those disclosed are considered equivalents thereof.

While certain present preferred embodiments of the invention have been illustrated and described herein, it is to be understood that the invention is not limited thereto. Clearly, the invention may be otherwise variously embodied, and practiced within the scope of the following claims.

What is claimed is:

1. A method for storing at least one content provided by a network host, the method comprising:
detecting an event corresponding to storing of the content; and
storing the content and retrieval information corresponding to the content in a mapped relationship at a non-host location,
wherein the retrieval information is information of searchable type based on information present in the content.

2. The method as claimed in claim 1, wherein the non-host location comprises one or more of a web browser application, a local memory, a local network, a local device, a local database and a location other than the network host.

3. The method as claimed in claim 1, wherein the content is automatically stored in the non-host location based on the retrieval information.

4. The method as claimed in claim 1, further comprising storing further information in mapped relation with the content, wherein the further information comprises one or more of information related to the content, information related to the storage, and information obtained from a user.

5. The method as claimed in claim 4, wherein the information related to the storage comprises one or more of time of storing and location of storing.

6. The method as claimed in claim 4, wherein the information related to the content comprises one or more of a name of the content, a type of the content, a size of the content, a source of the content, an address of the source of the content, and metadata related to the content.

7. The method as claimed in claim 4, wherein the information obtained from the user comprises one or more of user details, rating as provided by the user to the content, number of times the content has been viewed, and remarks as provided by the user to the content.

8. The method as claimed in claim 4, wherein the information related to the content is retrieved prior to storing of the content at the non-host location or is retrieved post storing of the content at the non-host location.

9. The method as claimed in claim 4, wherein the information related to the storage is retrieved post storing of the content at the non-host location.

10. The method as claimed in claim 4, wherein the information obtained from the user is retrieved prior to storing of the content at the non-host location or is retrieved post storing of the content at the non-host location or is retrieved post a user action on the content at the non-host location.

11. The method as claimed in claim 1, further comprising:
detecting an event corresponding to storing of a plurality of contents;
storing each of the plurality of contents and retrieval information corresponding to each of the plurality of contents in a mapped relationship at the non-host location.

12. The method as claimed in claim 1, further comprising displaying information of at least one stored content in a graphical user interface within a browser,
wherein displaying information of the stored content comprises displaying a menu in a graphical user interface within the browser.

13. The method as claimed in claim 12, further comprising creating a menu corresponding to the at least one stored content.

14. The method as claimed in claim 1, wherein the information of the searchable type comprise at least one of text information, image information, audio information, and video information.

15. An apparatus for storing at least one content provided by a network host, the apparatus comprising:
a browser module for detecting an event corresponding to storing of the content; and
a storing module for storing the content and retrieval information corresponding to the content in a mapped relationship at a non-host location,
wherein the retrieval information is information of searchable type based on information present in the content.

16. The apparatus as claimed in claim 15, wherein the non-host location comprises one or more of a web browser application, a local memory, a local network, a local device, a local database and a location other than the network host.

17. The apparatus as claimed in claim 15, wherein the content is automatically stored in the non-host location based on the retrieval information.

18. The apparatus as claimed in claim 15, further comprising storing further information in mapped relation with the content, wherein the further information comprises one or more of information related to the content, information related to the storage, and information obtained from a user.

19. The apparatus as claimed in claim 18, wherein the information related to the storage comprises one or more of time of storing and location of storing.

20. The apparatus as claimed in claim 18, wherein the information related to the content comprises one or more of a name of the content, a type of the content, a size of the content, a source of the content, an address of the source of the content, and metadata related to the content.
